(19) United States
(12) Patent Application Publication
(10) Pub. No.: US 2021/0297620 A1
(43) Pub. Date: Sep. 23, 2021

(54) MEASUREMENT APPARATUS FOR CAMERA MODULE

(71) Applicant: Global Mixed-mode Technology Inc., Hsin-Chu (TW)

(72) Inventor: Chia-Wei Ho, Hsinchu City (TW)

(21) Appl. No.: 16/823,262

(22) Filed: Mar. 18, 2020

(51) Int. Cl. H04N 5/3745; H04N 5/66

(52) U.S. Cl. CPC H04N 5/37455; H04N 5/66; H04N 5/37457

(57) ABSTRACT

A measurement apparatus for a camera module includes a constant current driver, a light emitting element, a resistor, a light receiving element, an amplifier, and a control unit. The constant current driver is coupled to the light emitting element. The light receiving element is coupled to the resistor for generating an output current. When the camera module moves toward the light receiving element and the light emitting element, the relative output current generated from the light receiving element will be changed according to a distance between the camera module and the light receiving element. The motor characteristics (e.g., posture difference, resonant frequency) of the camera module may be measured by such method as a result.

### BACKGROUND OF THE INVENTION

### 1. Field of the Invention

The present invention relates to a measurement apparatus, and more particularly, to a measurement apparatus for a camera module.

### 2. Description of the Prior Art

Conventionally, an expensive laser rangefinder is required when it is needed to measure some motor characteristics (e.g., posture difference, resonant frequency) of a camera module. Since the laser rangefinder is very expensive, the overall cost will increase tremendously if all motor characteristics are needed to be measured and corrected for each camera module. Moreover, since the laser rangefinder is too heavy, the gravity may inevitably change the distance between the laser rangefinder and the camera module during the procedure of measuring the posture difference, which results in an inaccurate measurement.

Thus, what is needed is a low-cost measurement apparatus for a camera module that is capable of measuring the motor characteristics in an accurate way.

### SUMMARY OF THE INVENTION

According to the present invention, a measurement apparatus for a camera module comprises a constant current driver, a light emitting element, a resistor, a light receiving element, an amplifier, and a control unit. The constant current driver is coupled to the light emitting element. The light receiving element is coupled to the resistor for generating an output current.

When the camera module moves toward the light receiving element and the light emitting element, the relative output current will be changed because of the change in the distance between the camera module and the light receiving element. The motor characteristics (e.g., posture difference, resonant frequency) of the camera module can be measured by such method as a result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a block diagram showing a measurement apparatus for a camera module according to one embodiment of the present invention;

FIG. 2 is a characteristic curve showing a relative output current versus a distance according to one embodiment of the present invention;

FIG. 3 is a flowchart showing a method for measuring the motor characteristics according to one embodiment of the present invention; and

FIG. 4 is a diagram showing a measurement apparatus for a camera module according to one embodiment of the present invention.

### DETAILED DESCRIPTION

Preferred embodiments according to the present invention will be described in detail with reference to the drawings.

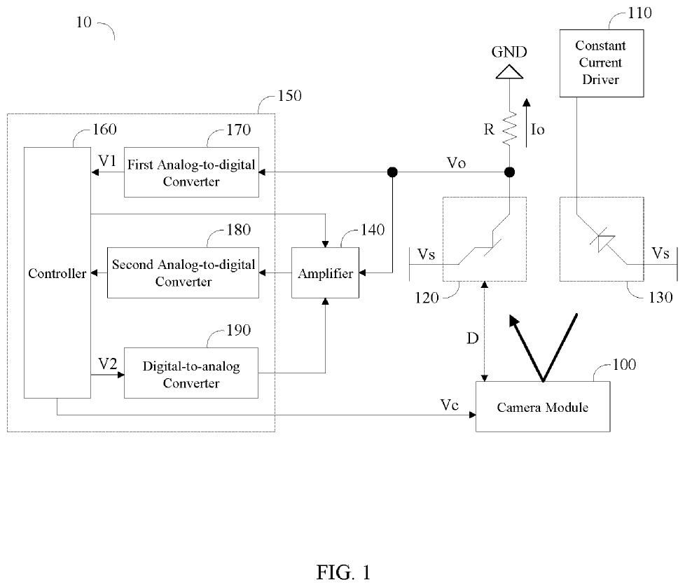

FIG. 1 is a block diagram showing a measurement apparatus 10 for a camera module 100 according to one embodiment of the present invention. The measurement apparatus 10 comprises a constant current driver 110, a light emitting element 130, a resistor R, a light receiving element 120, an amplifier 140, and a control unit 150. The control unit 150 comprises a controller 160, a first analog-to-digital converter 170, a second analog-to-digital converter 180, and a digital-to-analog converter 190. The second analog-to-digital converter 180 is coupled to the amplifier 140 and the controller 160. The amplifier 140 is coupled to the controller 160 and the digital-to-analog converter 190 for receiving some parameters of the amplifier 140. The light emitting element 130 may be an infrared emitting diode and the light receiving element 120 may be a phototransistor. The light emitting element 130 is coupled to a voltage source Vs. The constant current driver 110 is coupled to the light emitting element 130 so as to provide a constant-current driving for the light emitting element 130. The light receiving element 120 is coupled to the resistor R for generating an output current Io. Furthermore, the light receiving element 120 is coupled to the first analog-to-digital converter 170 and the amplifier 140 for generating an output voltage Vo to the first analog-to-digital converter 170 and the amplifier 140. The camera module 100 comprises a motor for performing an auto-focus function. A distance between the camera module 100 and the light receiving element 120 is D.

The light emitting element 130 and the light receiving element 120 are utilized for measuring the motor characteristics of the camera module 100. When the light emitting from the light emitting element 130 reaches the camera module 100, the light will be reflected by the camera module 100 and then enters the light receiving element 120. When the light receiving element 120 receives the light, it is capable of generating the output current Io for measurement.

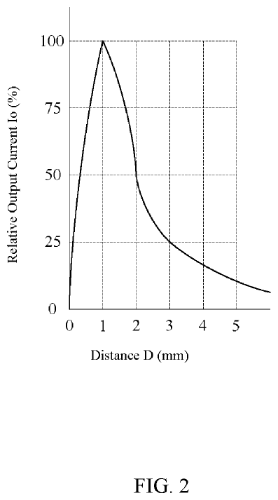

FIG. 2 is a characteristic curve showing the relative output current Io versus the distance D according to one embodiment of the present invention. When the camera module 100 moves toward the light receiving element 120, the relative output current Io will change according to the distance D. Thus, the characteristic curve may be used for measuring the motor characteristics (e.g., posture difference, resonant frequency) of the camera module 100.

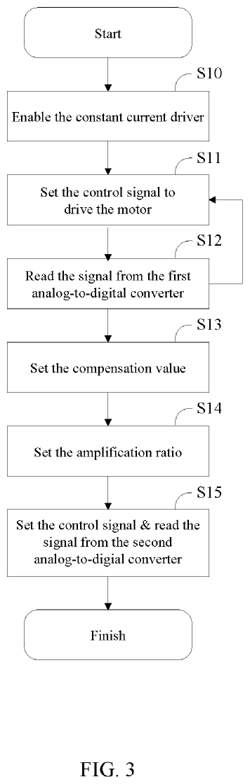

FIG. 3 is a flowchart showing a method for measuring the motor characteristics according to the present invention. Referring to FIG. 1 and FIG. 3, first, the constant current driver 110 is enabled (S10) before starting the measurement, so that the light emitting element 130 is driven by a constant current and the constant current does not change as the voltage source Vs and a working temperature change. Then, the controller 160 generates a control signal Vc to the camera module 100, thereby driving the motor to a first position (S11). The first analog-to-digital converter 170 converts the output voltage Vo into a first voltage signal V1, and then the first voltage signal V1 is received by the controller 160 (S12). The controller 160 generates a second voltage signal V2 to the digital-to-analog converter 190 based on the first voltage signal V1, so as to provide a compensation value Voff to the amplifier 140 (S13), wherein the compensation value Voff is smaller than the output voltage Vo. Then the controller 160 drives the motor to a second position. The controller 160 provides an amplification ratio A to the amplifier 140 (S14) after computation based on the first voltage signal V1 obtained from the first position and the second position, wherein the amplification ratio A is determined by the difference value between the output voltage Vo and the compensation value Voff. After setting the compensation value Voff and the amplification ratio A, the motor characteristics (e.g., posture difference, resonant frequency) may be measured based on the signals transmitting from the amplifier 140 and the second analog-to-digital converter 180 (S15).

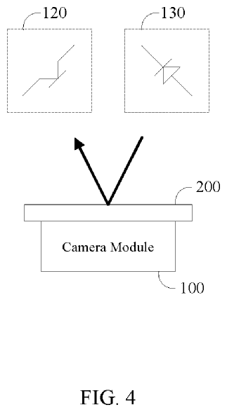

FIG. 4 is a diagram showing the measurement apparatus 10 for the camera module 100 according to one embodiment of the present invention. The measurement apparatus 10 further comprises a flat material 200 (e.g., white paper, white mask). The flat material 200 is attached on a surface of the camera module for enhancing a light intensity entering the light receiving element 120. Also, the flat material 200 may surround the light receiving element 120 or the light emitting 130 for enhancing the light intensity of the light entering the light receiving element 120.

The present invention provides the low-cost measurement apparatus 10 for the camera module 100 when compared with the conventional laser rangefinder, so that a mass production is possible. Moreover, when the measurement apparatus 10 needs to be rotated 90 degrees, 180 degrees, or 270 degrees for measuring the posture difference, the distance D between the camera module 100 and the photo receiving element 120 will not substantially be changed owing to the light weight of the measurement apparatus 10, thereby decreasing the measurement error resulting from the gravity tremendously.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A measurement apparatus for a camera module, comprising:
a light emitting element;
a voltage source, coupled to the light emitting element;
a constant current driver, coupled to the light emitting element;
a resistor; and
a light receiving element, coupled to the resistor for generating an output current and an output voltage, wherein:
when the camera module moves toward the light receiving element and the light emitting element, the output current and a distance between the camera module and the light receiving element are used as a basis for measuring a motor characteristic of the camera module.

2. The measurement apparatus of claim 1, further comprising:
an amplifier, coupled to the light receiving element; and
a control unit, coupled to the amplifier and configured to provide a parameter to the amplifier.

3. The measurement apparatus of claim 2, wherein the control unit comprises:
a first analog-to-digital converter, coupled to the light receiving element;
a second analog-to-digital converter, coupled to the amplifier;
a digital-to-analog converter, coupled to the amplifier; and
a controller, coupled to the amplifier, the first analog-to-digital converter, the second analog-to-digital converter, and the digital-to-analog converter, so as to provide a compensation value and an amplification ratio to the amplifier.

4. The measurement apparatus of claim 2, wherein the parameter is a compensation value or an amplification ratio.

5. The measurement apparatus of claim 3, wherein the compensation value is smaller than the output voltage.

6. The measurement apparatus of claim 3, wherein the amplification ratio is determined by the difference value between the output voltage and the compensation value.

7. The measurement apparatus of claim 1, further comprising a flat material for enhancing a light intensity of a light entering the light receiving element.

8. The measurement apparatus of claim 7, wherein the flat material is attached on a surface of the camera module.

9. The measurement apparatus of claim 7, wherein the flat material surrounds the light receiving element.

10. The measurement apparatus of claim 7, wherein the flat material surrounds the light emitting element.

11. The measurement apparatus of claim 7, wherein the flat material is a white paper.

12. The measurement apparatus of claim 7, wherein the flat material is a white mask.

13. The measurement apparatus of claim 1, wherein a current flowing through the light emitting element does not change as the voltage source and a working temperature change.

14. The measurement apparatus of claim 1, wherein the light emitting element is an infrared light emitting diode.

15. The measurement apparatus of claim 1, wherein the light receiving element is a phototransistor.

16. The measurement apparatus of claim 1, wherein the motor characteristic is a posture difference.

17. The measurement apparatus of claim 1, wherein the motor characteristic is a resonant frequency.
